(19) United States
(12) Patent Application Publication
(10) Pub. No.: US 2025/0134630 A1
(43) Pub. Date: May 1, 2025

(54) COMBINED CIRCUIT BREAKER AND DISTALER

(71) Applicant: SMILERS LAB, Chambéry (FR)

(72) Inventor: Hubert DROY, BOURDEAU (FR)

(21) Appl. No.: 18/931,432

(22) Filed: Oct. 30, 2024

(30) Foreign Application Priority Data
Nov. 1, 2023 (FR) 2311909

(51) Int. Cl. A61C 7/10; A61C 7/06; A61C 7/22; A61C 8/00

(52) U.S. Cl. CPC A61C 7/10; A61C 7/06; A61C 7/22; A61C 8/0096

(57) ABSTRACT

The present invention relates to an orthodontic device (1) adapted to fit on the maxilla of a patient, comprising: A) at least one central expander (2) incorporating an expansion screw (4) allowing its expansion and, consequently, that of the patient's maxillary arch (AM), said central expander (2) being attached to:
A1) A first symmetrical pair of posterior retention arms (5), each retention arm (5) being coupled to a band (3) of a first pair of bands (3) allowing the device (1) to be fixed on the right and left permanent molars of the patient's maxillary arch (AM), at least one of the bands (3) also constituting the distal element of a distalization set (12) comprising at least two elements,
A2) At least one symmetrical pair of anterior retention arms (8), which rest on the palatal surface of the teeth in front of the right and left molars to which the first pair of right and left bands (3) are fixed;
A3) A second symmetrical pair of posterior retention arms (6), each retention arm (6) being formed of two distinct segments, with a first segment coupled to a band (3) of the first pair of bands (3) and a second segment coupled to the central expander (2), the first and second segments being connected by a joint (7).

The present application claims the priority of French patent application FR2311909 filed on Nov. 1, 2023, and incorporated herein by reference.

### FIELD OF THE INVENTION

The present invention relates to an orthodontic device that combines both the functions of an expander and a distalizer.

### PRIOR ART

The jaws are two opposing bony structures that form the mouth.

In mammals, the lower jaw or lower dental arch corresponds to the mobile component, referred to as the “mandible.”

The upper jaw or upper dental arch is more or less fixed to the skeleton. The latter is called the “maxilla” and is composed of two bones that are fused at the midline by a suture. The maxillary bones form the roof of the mouth, the floor.

In some cases, this upper jaw may prove to be too narrow. This is, for example, the case with an ogival palate, which is a malformation associated with a narrow and deep palate that narrows the nasal cavities. Such a malformation can result from genetic diseases such as CROUZON syndrome, DOWN syndrome (trisomy 21), or TURNER syndrome. It should be noted that, beyond the aesthetic issue for the patient, such a malformation can also affect the quality of their breathing.

To remedy such a narrowing of the maxillary arch, maxillary expansion is performed to restore the balance between the width of the jaws (maxilla and mandible) and, simultaneously, to facilitate the passage of air through the nasal cavity. In adults, this maxillary expansion is performed through a surgical technique called Surgically Assisted Rapid Palatal Expansion (SARPE). However, this maxillary expansion is possible in children through an orthodontic procedure without surgery due to a still unossified palatal suture. The technique used in children relies on an orthodontic device called an intermaxillary expander or palatal expander.

This palatal expander is fixed on the right and left permanent molars of the maxillary arch with bands. The right and left bands of the palatal expander are connected by retention arms to a central expander integrating an expansion screw allowing its activation (that is, its widening).

The activation of the palatal expander is generally performed 1 to 2 times a day and generates a force that will separate the two palatal bones at the intermaxillary suture, at a rate of about ¼ to ½ mm per day. This activation period generally lasts 2 to 4 weeks and is followed by a retention period (about 3 months) during which the device remains in place, but without further activation of the expansion screw. This retention period is essential to allow calcification of the opening area of the intermaxillary suture and thus stabilization of the maxillary expansion.

FIG. 1 shows a prior art palatal expander consisting of two bands (B) positioned at teeth 16 and 26 (first molar), to which retention arms (BR) are welded, resting on the palatal surface of the teeth. These retention arms allow for the coupling between the bands (and the support surfaces on the teeth) to a central expander (E) including an expansion screw (VE). The progressive and periodic activation of the central expander (E) using a key to turn the expansion screw (VE) of the central expander (E) thus spreads the maxillary arch (AM). It should be noted that in some cases, the palatal expander may include not two, but four bands positioned at teeth 14 and 24 (first premolar) and teeth 16 and 26 (first molar).

Now, it is sometimes necessary to make, in addition to this expansion, other corrections to the maxilla. It may be necessary to improve the relative position of a series of teeth. In this case, the correction is made using a distalizer, which is a separate orthodontic device designed to move one or more teeth backward. Distalization techniques differ depending on the tooth or teeth to be treated, with dedicated orthodontic devices for each.

Devices such as distalizers designed to move a series of teeth backward from a molar are known and are notably described in European patents EP 1 433 435 B1, EP 1 649 824 B1, EP 1 681 033 B1, EP 3 560 453 B1, and French patent FR 2 979 225 B1.

For patients requiring both intermaxillary expansion and maxillary distalization, practitioners will therefore have to combine these two devices (expander and distalizer). However, such a combination, apart from requiring an impression to be taken for each device to be made, will primarily result in a significant treatment time. Indeed, it will be necessary to complete the intermaxillary expansion, leaving the palatal expander in place until the intermaxillary suture area calcifies, before being able to remove this palatal expander and being able to put in place the distalizer to initiate distalization.

It goes without saying that the consecutive installation of two devices and the associated treatment time constitute as many inconveniences for patients.

### SUMMARY OF THE INVENTION

Faced with this issue, the inventor has now developed a new device that combines the functions of an expander and a distalizer. The device is capable of performing expansion and then, once the expansion is complete, performing distalization without compromising the immobilization of the maxillary arch necessary for the calcification of the opening area of the intermaxillary suture.

The device according to the invention allows these two orthodontic problems to be treated simultaneously, which were previously treated one after the other using an expander and then a distalizer. The treatment time is thus reduced, as distalization can be initiated without having to wait for the stabilization of the maxillary expansion, which takes at least 3 months. As a result, the discomfort for the patient is significantly reduced.

Moreover, the device according to the invention is less expensive than the two devices. It only requires one initial impression by the practitioner, and no removal of this device is necessary when transitioning from expansion to distalization.

Consequently, a first object of the invention relates to an orthodontic device, adapted to fit on the maxilla of a patient, comprising:

A) at least one central expander incorporating an expansion screw allowing its expansion and the subsequent expansion of the patient's maxillary arch, said central expander being attached to:
A1) A first symmetrical pair of posterior retention arms, each retention arm being coupled to a band of a first pair of bands allowing the device to be fixed on the right and left permanent molars of the patient's maxillary arch,
A2) At least one symmetrical pair of anterior retention arms resting on the palatal surface of teeth in front of the right and left molars to which are fixed the first pair of right and left bands;

Characterized in that:
the device further comprises A3) A second symmetrical pair of posterior retention arms, each retention arm being formed of two distinct segments with a first segment coupled to a band of the first pair of bands and a second segment coupled to the central expander, the first and second segments being associated by a joint;
And
at least one of the bands of the first pair of bands also constitutes the distal element of a set for the distalization of a succession of several teeth starting from the molar to which this band is fixed, the set comprising at least two elements.

Advantageously, the device further comprises at least B) a distalization set comprising at least two elements.

A second object of the invention relates to a kit comprising a device as described above, at least one holding element intended to be fixed to a mandibular tooth, and at least one return member intended to couple the distalization set and the holding element to allow distalization.

### DESCRIPTION OF THE FIGURES

FIG. 1 shows a palatal expander according to the prior art.

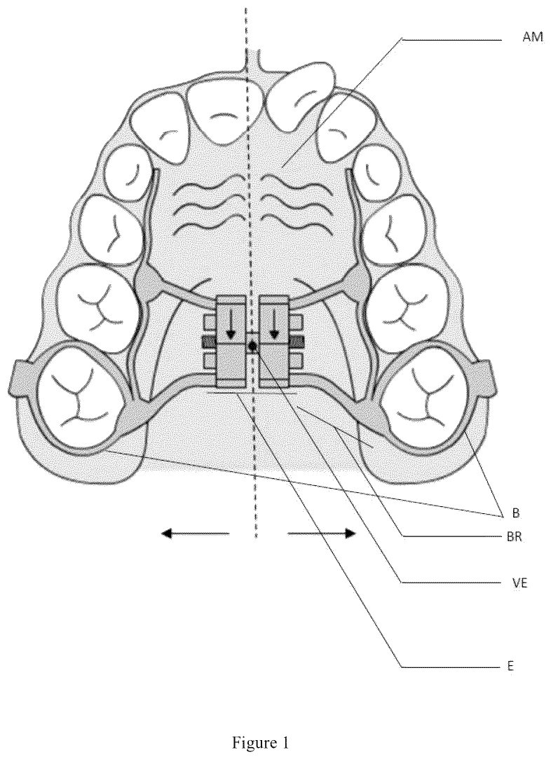

FIG. 2 shows an embodiment of the device according to the invention, after its installation on the patient's maxilla, and before starting the first expansion phase.

FIG. 3 shows the same embodiment of the device according to the invention, at the end of the first expansion phase.

FIG. 4 shows the same embodiment of the device according to the invention, at the end of the first expansion phase.

FIG. 5 shows a preferred embodiment of the distalization set to be integrated into the orthodontic device according to the invention.

### DETAILED DESCRIPTION OF THE INVENTION

Expanders adapted to perform maxillary arch expansion are well known to those skilled in the art and take the form of a jack. As explained previously, these expanders (e.g., HYRAX expander; DENTAURUM) consist of two parts (right and left) connected by an expansion screw. This expansion screw is pierced with at least 2 holes (typically 4, spaced 450 apart). The insertion of a key into the accessible hole of the expansion screw allows the screw to be moved by rotating the key, which rotation triggers the activation of the expander and thus spreads the maxillary arch. As examples of such expanders, one can cite those described in PCT applications WO9302629, WO9520924, WO9810708A1, WO03071976A1, WO2008141314A1, WO 2012/120447, and WO2016120897.

Advantageously, the expansion screw of the expander includes a stop. Such a stop makes it possible to halt the expansion once the desired expansion value for the maxillary arch has been reached and, preferably, to prevent the dislocation of the expander.

Still advantageously, the expander may also include a backstop system. Such a backstop system ensures safe and effective expansion by preventing improper manipulation of the expansion screw.

The expander may also include a visual marker indicating, to the user, the direction of rotation of the expansion screw. Such a visual marker can simply be represented by an arrow. This arrow may be made during the manufacturing process of the expander or afterward through laser marking.

The retention arms used in expander-type devices are well known to those skilled in the art. They are rigid elements that take the form of metal wires with an appropriate cross-section (1 mm diameter or larger). During the installation of the device, the practitioner can easily adjust the shape of the retention arms by bending them.

Advantageously, each retention arm of the first symmetrical pair of posterior retention arms will include one or more predetermined break points along its length. Preferably, each of these retention arms includes at least two predetermined break points, with a first one located near the central expander and a second one located near the band to which this retention arm is coupled. In this way, once the desired expansion value has been reached, the practitioner can remove this retention arm to allow for distalization. Following the removal of the first symmetrical pair of posterior retention arms, the practitioner can, simply and using available instruments, smooth out the angles of the used break points to avoid injuring the patient.

The bands of the first pair of bands are advantageously fixed to teeth 16 and 26 (first molar). The size of these bands is defined for each patient based on the size of the tooth they will surround. Each band is then force-fitted by the practitioner and adjusted around the corresponding molar.

Advantageously, and for reinforcement purposes, the left and/or right posterior and anterior retention arms are connected by a palatal reinforcement wire. Such a palatal reinforcement wire typically takes the form of a rigid metal wire (e.g., REMALOY wire, ø 1.0 mm), which is connected (e.g., laser welded) to the left and/or right posterior and anterior retention arms. Preferably, this palatal reinforcement wire rests on the palatal surface of the adjacent teeth. Such support helps better distribute expansion forces and improve the efficiency of the corresponding orthodontic device.

Still advantageously, if the device according to the invention includes such a palatal reinforcement wire, the palatal reinforcement wire will include one or more predetermined break points along its length. Preferably, this palatal reinforcement wire includes at least two predetermined break points, with a first one located near the posterior retention arm and a second one located near the anterior retention arm. In this way, once the desired expansion value has been reached, the practitioner can remove this palatal reinforcement wire when installing the distalization device. This removal is indeed essential to allow distalization. Following the removal of the palatal reinforcement wire, the practitioner can, simply and using available instruments, smooth out the angles of the used break points to avoid injuring the patient.

Regarding the support of the pair of anterior retention arms, such support may take the form of a second pair of bands, usually fixed to teeth 14 and 24 (first premolar). Now, this support will preferably take the form of a rigid metal wire, typically an extension of the palatal reinforcement wire in front of the anterior retention arm if such a palatal reinforcement wire is present. Such a rigid metal wire typically rests on the palatal surface of teeth 14 and 24 (first premolar) and may extend over the palatal surface of the teeth beyond (13 and 23 at least). Preferably, each anterior retention arm is coupled to a rigid metal wire (e.g., by welding), which corresponds to an extension of the palatal reinforcement wire when present, and rests on the palatal surface of at least one tooth in front of this anterior retention arm.

In cases where the support of the pair of anterior retention arms on the palatal surface of the teeth in front of the right and left molars to which the first pair of right and left bands are fixed takes the form of a rigid metal wire, this palatal support may be coupled with an additional occlusal support (on top of the teeth), which prevents the device from sinking into the tissues. Preferably, each rigid metal wire that rests on the palatal surface of at least one tooth in front of the anterior retention arm is coupled with at least one second rigid metal wire (e.g., by welding) that provides occlusal support. To further improve the stability of the device according to the invention, such occlusal support may be bonded to the tooth.

Regarding the second symmetrical pair of posterior retention arms, its two joints (one for each arm of this second pair of posterior retention arms) are essential for the distalization phase.

When the expansion phase is complete, the practitioner indeed removes the first pair of posterior retention arms (and the associated palatal reinforcement wires, if present). This removal releases the constraint on the two joints of this second symmetrical pair of posterior retention arms. These two joints then provide the device with an additional degree of freedom (allowing articulation at the bands), which is necessary for distalization, while maintaining the expansion of the maxillary arch required for the retention stage of the expansion.

Advantageously, each joint takes the form of a ball-and-socket joint, preferably a spherical ball-and-socket joint.

As for the distalization, it was previously mentioned that at least one of the bands from the first pair of bands constitutes the distal element of a set for the distalization of a series of multiple teeth starting from the molar on which this band is fixed, which distalization set comprises at least two elements.

Such distalization sets comprising at least two elements and intended to move a series of multiple teeth backward from a molar are well known to those skilled in the art and are notably described in European patents EP 1 433 435 B1 and EP 3 560 453 B1, as well as in French patent FR 2 979 225 B1.

To perform distalization, a return member is attached to the anterior part of the distalization set (typically an elastic loop) and to a holding element (usually a plate with a hook) fixed to a mandibular tooth, according to a classical arrangement.

According to a first embodiment, and based on the teachings of patent EP 1 433 435 B1, such a distalization set would comprise:
1) A distal element including a band fixed to the molar with, on its buccal surface, a coupling box, and
2) A mesial element that can be attached by its base to a canine (e.g., with glue or cement) in front of the molar, the mesial element having an anterior projection with an outer part that allows for the retention of an elastic element (associated with this set to enable distalization) and a posterior curved projection ending in a spherical joint at its tip,
Where the spherical joint of the mesial element is inserted into the coupling box of the distal element.

The details of the possible structures of the mesial element and the coupling box are described in detail in patent EP 1 433 435 B1 and are therefore not described further here.

According to a second embodiment, and based on the teachings of French patent FR 2 979 225 B1 (the numerical references below correspond to those used in this French patent), such a distalization set would comprise:
1) A distal element, corresponding to the rear head of the distalization set, comprising a band fixed to the molar and provided, on its buccal surface, with a mounting accessory that includes a sleeve;
2) A front fixing head that includes an adaptation plate on a canine and a bent rod that holds this plate; and
3) An intermediate element comprising an anteroposterior arm and two joints located opposite each other on the anteroposterior arm, one of which connects the anteroposterior arm to the front fixing head and the other connects the anteroposterior arm to the mounting accessory fixed on the buccal surface of the band.

In this embodiment, a portion of the bent rod opposite the intermediate element extends outward and forms a hook to attach a return member of the distalization set, generally towards the rear.

The following examples are provided for illustration purposes and should not limit the scope of the present invention.

### Performing Successive Expansion and Distalization on a Patient's Maxilla

In a first phase, the practitioner takes an impression of the patient's maxilla.

This impression allows for the creation of an orthodontic device according to the invention (1) with dimensions adapted for placement on the maxilla and also to allow for the desired expansion and distalization.

Once the orthodontic device (1) has been made, the practitioner will place it on the patient's maxilla.

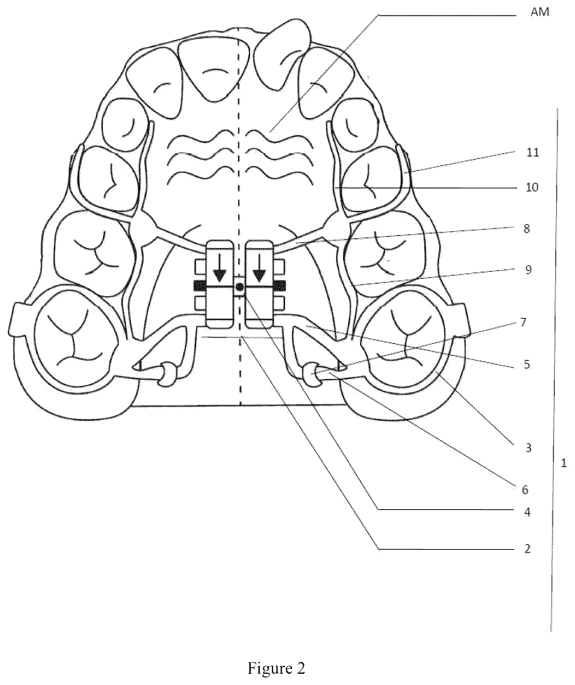

FIG. 2 shows an orthodontic device according to the invention (1) in the first phase of distalization. It consists of two bands (3) positioned on teeth 16 and 26 (first molar), to which a first symmetrical pair of posterior retention arms (5) and a second symmetrical pair of posterior retention arms (6) are welded, each of which includes a ball-and-socket joint (7). These retention arms (5, 6) allow the coupling between the bands (3) and a central expander (2) containing an expansion screw (4). The central expander (2) is attached to a symmetrical pair of anterior retention arms (8), which rest on the palatal surface of teeth located in front of the right and left molars to which the first pair of right and left bands (3) are fixed. A palatal reinforcement wire (9) connects the arms of the first symmetrical pair of posterior retention arms (5) to the arms of the symmetrical pair of anterior retention arms (8). An extension of the palatal reinforcement wire (10) in front of the anterior retention arm rests on the palatal surface of the teeth. This extension of the palatal reinforcement wire (10) is coupled with an occlusal support (11) in the form of a rigid metal wire. The progressive daily activation of the central expander (2) by means of a key, which turns the expansion screw (4) of the central expander (2), thus expands the maxillary arch (AM) until the desired value is reached.

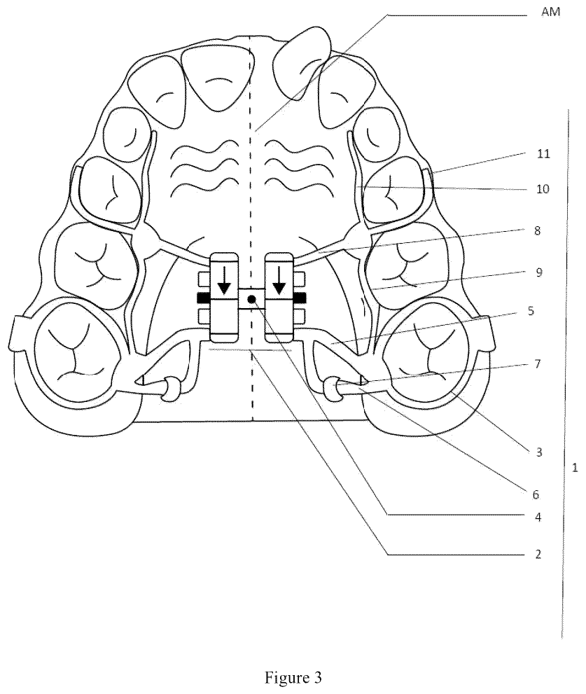

FIG. 3 shows this same device (1) according to the invention at the end of the maxillary arch (AM) expansion phase.

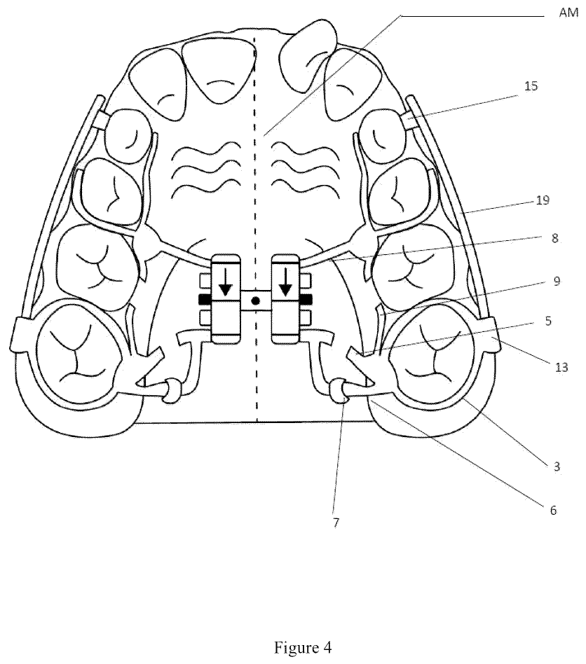

As illustrated in FIG. 4, the practitioner then removes the first symmetrical pair of posterior retention arms (5) to release the constraint on the two ball-and-socket joints (7) of the second symmetrical pair of posterior retention arms (6). The device according to the invention thus maintains the expansion of the maxillary arch (AM) during the retention phase. The practitioner then removes the palatal reinforcement wire (9) connecting the retention arms of the first pair of posterior retention arms (5) to the anterior retention arms (8). This removal is necessary to allow distalization. To carry out the distalization phase, the practitioner installs the set for distalizing a series of several teeth from the molar to which the band (3) is attached, which includes a mounting accessory (13) that connects to an anteroposterior arm (19), which is connected to a front fixing head (15) attached to a canine.

To perform the distalization, the practitioner places a holding element on a mandibular molar below the distalization set and connects this holding element and the anterior part of the distalization set with a return member to allow distalization. Such a holding element takes the form of a mounting plate with a hook, and the return member takes the form of an elastic band.

After a period of at least 3 months, which allows the completion of the retention phase of the expansion and, simultaneously, the distalization phase, the practitioner can remove the device from the patient's maxilla.

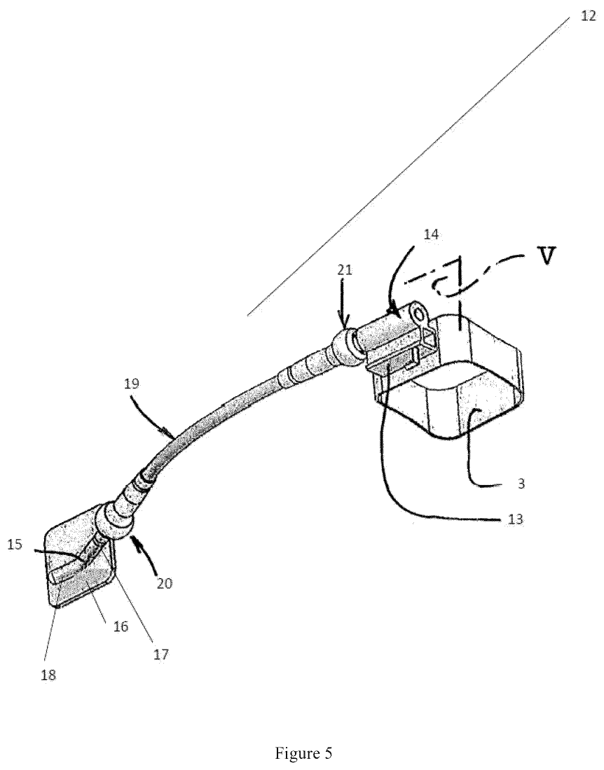

The preferred embodiment of the distalization set (12) is described in FIG. 5 and includes the following details:
1. The band (3) attached to the molar, to which the expander (2, not shown in this figure) is coupled, with a mounting accessory (13) provided on its buccal surface (V) that includes a sleeve (14).
2. A front fixing head (15) that includes an adaptation plate (16) on a canine and a bent rod (17) that holds this plate (16). A portion of this bent rod (17) forms a hook (18) for attaching a return member of the distalization set (12), generally toward the rear.
3. An intermediate set comprising an anteroposterior arm (19) and two joints (20, 21) located opposite each other on the anteroposterior arm (19), one joint (20) connecting the anteroposterior arm (19) to the front fixing head (15) and the other joint (21) connecting the anteroposterior arm (19) to the mounting accessory (13) attached to the buccal surface (V) of the band (3).

### REFERENCE LIST

1: Orthodontic device
2: Expander
3: Bands of the first pair of bands
4: Expansion screw of the expander
5: Retention arms of the first symmetrical pair of posterior retention arms
6: Retention arms of the second symmetrical pair of posterior retention arms
7: Joint of the retention arms of the second symmetrical pair of posterior retention arms
8: Arms of the symmetrical pair of anterior retention arms
9: Palatal reinforcement wire connecting the arms of the first symmetrical pair of posterior retention arms to the arms of the symmetrical pair of anterior retention arms
10: Extension of the palatal reinforcement wire in front of the anterior retention arm, which rests on the palatal surface of the teeth
11: Occlusal support
12: Distalization set
13: Mounting accessory
14: Sleeve
15: Front fixing head
16: Adaptation plate
17: Bent rod
18: Hook for attaching a return member of the distalization set formed by the bent rod
19: Anteroposterior arm
20: Joint connecting the anteroposterior arm (19) to the front fixing head (15)
21: Joint connecting the anteroposterior arm (19) to the mounting accessory (13) attached to the buccal surface (V) of the band (3)

1. An orthodontic device (1) adapted to fit on the maxilla of a patient, comprising A) at least one central expander (2) incorporating an expansion screw (4) allowing its expansion and, consequently, that of the patient's maxillary arch (AM), said central expander (2) being attached to:
A1) A first symmetrical pair of posterior retention arms (5), each retention arm (5) being coupled to a band (3) of a first pair of bands (3) allowing the device (1) to be fixed on the right and left permanent molars of the patient's maxillary arch (AM),
A2) At least one symmetrical pair of anterior retention arms (8), which rest on the palatal surface of the teeth in front of the right and left molars to which the first pair of right and left bands (3) are fixed;
wherein the said A) at least one central expander (2) is also attached to A3) A second symmetrical pair of posterior retention arms (6), each retention arm (6) being formed of two distinct segments, with a first segment coupled to a band (3) of the first pair of bands (3) and a second segment coupled to the central expander (2), the first and second segments being connected by a joint (7); and
at least one of the bands (3) of the first pair of bands (3) also constitutes the distal element of a B) set for the distalization (12) of a series of multiple teeth from the molar to which this band (3) is attached, said distalization set (12) comprising at least two elements.

2. The orthodontic device (1) of claim 1, wherein each joint (7) takes the form of a ball-and-socket joint (7), preferably a spherical ball-and-socket joint (7).

3. The orthodontic device (1) of claim 1, wherein each retention arm (5) of the A1) first symmetrical pair of posterior retention arms (5) includes one or more predetermined break points along its length.

4. The orthodontic device of claim 1, wherein the left and/or right posterior (5) and anterior (8) retention arms are connected by a palatal reinforcement wire (9).

5. The orthodontic device of claim 4, wherein said palatal reinforcement wire (9) includes one or more predetermined break points along its length.

6. The orthodontic device of claim 4, wherein the support of the pair of anterior retention arms (8) takes the form of an extension (10) of the palatal reinforcement wire (9) in front of the anterior retention arm (8).

7. The orthodontic device of claim 1, wherein the distalization set (12) comprises a distal element including a band (3) fixed to the molar, with a coupling box on its buccal surface, and a mesial element fixed by its base to a canine in front of the molar, said mesial element comprising an anterior projection with an outer part allowing for the retention of a return member, and a posterior curved projection ending in a spherical joint at its tip, where the spherical joint of the mesial element is inserted into the coupling box of the distal element.

8. The orthodontic device of claim 1, wherein the B) distalization set (12) comprises:
1) a distal element, corresponding to the rear head of the distalization set (12), including a band (3) fixed to the molar and provided, on its buccal surface, with a mounting accessory (13) that includes a sleeve (14);
2) a front fixing head (15) that includes an adaptation plate (16) on a canine and a bent rod (17) that holds this plate; and
3) an intermediate element comprising an anteroposterior arm (19) and two joints (20, 21) located opposite each other on the anteroposterior arm (19), one joint (20) connecting the anteroposterior arm (19) to the front fixing head (15), and the other joint (21) connecting the anteroposterior arm (19) to the mounting accessory (13) attached to the buccal surface (V) of the band (3).

9. A kit comprising at least one orthodontic device adapted to fit on the maxilla of a patient, at least one holding element intended to be attached to a mandibular tooth, and at least one return member intended to couple the distalization set and the holding element to allow distalization, wherein the orthodontic device (1) comprises A) at least one central expander (2) incorporating an expansion screw (4) allowing its expansion and, consequently, that of the patient's maxillary arch (AM), said central expander (2) being attached to:
A1) A first symmetrical pair of posterior retention arms (5), each retention arm (5) being coupled to a band (3) of a first pair of bands (3) allowing the device (1) to be fixed on the right and left permanent molars of the patient's maxillary arch (AM),
A2) At least one symmetrical pair of anterior retention arms (8), which rest on the palatal surface of the teeth in front of the right and left molars to which the first pair of right and left bands (3) are fixed;
wherein the said A) at least one central expander (2) is also attached to A3) a second symmetrical pair of posterior retention arms (6), each retention arm (6) being formed of two distinct segments, with a first segment coupled to a band (3) of the first pair of bands (3) and a second segment coupled to the central expander (2), the first and second segments being connected by a joint (7); and
at least one of the bands (3) of the first pair of bands (3) also constitutes the distal element of a B) set for the distalization (12) of a series of multiple teeth from the molar to which this band (3) is attached, said distalization set (12) comprising at least two elements.

10. The kit of claim 9, wherein each joint (7) takes the form of a ball-and-socket joint (7), preferably a spherical ball-and-socket joint (7).

11. The kit of claim 9, wherein each retention arm (5) of the A1) first symmetrical pair of posterior retention arms (5) includes one or more predetermined break points along its length.

12. The kit of claim 9, wherein the left and/or right posterior (5) and anterior (8) retention arms are connected by a palatal reinforcement wire (9).

13. The kit of claim 12, wherein said palatal reinforcement wire (9) includes one or more predetermined break points along its length.

14. The kit of claim 12, wherein the support of the pair of anterior retention arms (8) takes the form of an extension (10) of the palatal reinforcement wire (9) in front of the anterior retention arm (8).

15. The kit of claim 9, wherein the distalization set (12) comprises a distal element including a band (3) fixed to the molar, with a coupling box on its buccal surface, and a mesial element fixed by its base to a canine in front of the molar, said mesial element comprising an anterior projection with an outer part allowing for the retention of a return member, and a posterior curved projection ending in a spherical joint at its tip, where the spherical joint of the mesial element is inserted into the coupling box of the distal element.

16. The kit of claim 9, wherein the B) distalization set (12) comprises:
1) a distal element, corresponding to the rear head of the distalization set (12), including a band (3) fixed to the molar and provided, on its buccal surface, with a mounting accessory (13) that includes a sleeve (14);
2) a front fixing head (15) that includes an adaptation plate (16) on a canine and a bent rod (17) that holds this plate; and
3) an intermediate element comprising an anteroposterior arm (19) and two joints (20, 21) located opposite each other on the anteroposterior arm (19), one joint (20) connecting the anteroposterior arm (19) to the front fixing head (15), and the other joint (21) connecting the anteroposterior arm (19) to the mounting accessory (13) attached to the buccal surface (V) of the band (3).
